(19) United States
(12) Patent Application Publication
(10) Pub. No.: US 2011/0129054 A1
(43) Pub. Date: Jun. 2, 2011

(54) PROCESSING FOR CODED APERTURE IMAGING

(75) Inventors: Geoffrey Derek DE VILLIERS, Malvern (GB); Kevin Dennis RIDLEY, Malvern (GB); Christopher William SLINGER, Malvern (GB); Malcolm John Alexander STRENS, Malvern (GB)

(73) Assignee: QINETIQ LIMITED, LONDON (GB)

(21) Appl. No.: 13/057,613

(22) PCT Filed: Jul. 30, 2009
(86) PCT No.: PCT/GB09/01870

§ 371 Date: Feb. 4, 2011

(30) Foreign Application Priority Data
Aug. 8, 2008 (GB) 0814562.5

(51) Int. Cl. G01N 23/00

(52) U.S. Cl. 378/2

(57) ABSTRACT

A method of reconstructing an image of a scene (4) from data output by a detector (8) in a coded aperture imaging system (2) comprises taking multiple frames of data using a different coded aperture array 6 for each frame. For each frame of data a decoding pattern is employed which is point source diffraction pattern corresponding to the coded aperture array used to acquire that frame. The decoding patterns are combined in a Gram matrix. A two-dimensional to one-dimensional mapping is applied to the frames of data. A solution to the data is constructed which is related to the scene (4) by an integral operator. The integral operator has an averaging kernel with a main lobe width which is smaller than the detector pixel size. Processing of the data yields an image which has sub-pixel resolution, i.e. resolution greater than the native resolution of the detector (8).

This invention relates to methods for processing image data acquired in a coded imaging system, especially to a method for achieving sub-pixel image resolution.

Coded aperture imaging is a known imaging technique which is primarily used in high energy imaging such as X-ray or γ-ray imaging where suitable lens materials do not generally exist, see e.g. E. Fenimore and T. M. Cannon, “Coded aperture imaging with uniformly redundant arrays”, Applied Optics, Vol. 17, No. 3, pages 337-347, 1 Feb. 1978. It has also been proposed for three dimensional imaging, see e.g. “Tomographical imaging using uniformly redundant arrays” Cannon T M, Fenimore E E, Applied Optics 18, no. 7, p. 1052-1057 (1979).

Coded aperture imaging exploits pinhole camera principles: however, instead of a single small aperture, a coded aperture mask having an array of small apertures is used. In a coded aperture imaging system, radiation passes from a scene through the mask to a detector comprising a pixel array, which provides an output for signal processing. The small size of the mask apertures results in high angular resolution, and increasing the number of apertures increases the radiation arriving at the detector thus improving signal to noise ratio. Each aperture passes an image of the scene to the detector, which therefore receives a pattern comprising a series of overlapping images not recognisable as the scene. Reconstruction processing is needed to produce a recognisable image of the scene from the detector output.

Reconstruction processing requires knowledge of the mask's aperture array and system configuration, and the aperture array is often coded to allow subsequent good quality image reconstruction. Such processing is performed using a mathematical model of the particular aperture array at a set location.

Busboom et al. “Coded aperture imaging with multiple measurements” J. Opt. Soc. Am. A, Vol. 14, No. 5, May 1997 propose a coded aperture imaging technique which takes multiple measurements of the scene, each acquired with a different coded aperture array. Busboom et al. discuss performing image reconstruction using a cross correlation technique and, considering quantum noise of the source, they discuss the choice of arrays that maximise signal to noise ratio. Conventional coded aperture imaging can be thought of as a geometric imaging technique: for its usual applications, e.g. astronomy, diffraction is negligible. The technique proposed by Busboom et al. is not concerned with diffraction and hence the effects of diffraction on image reconstruction are not discussed.

As used in this specification an overall pattern displayed on the coded aperture mask apparatus will be described as a coded aperture mask. At least part of the coded aperture mask will comprise a coded aperture array and the term coded aperture array shall refer to the part of the mask comprising the arrangement of apertures in the mask. The whole pattern displayed on the mask apparatus may be a coded aperture array or only part of the mask may comprise a coded aperture array, with the rest of the mask being opaque. For the avoidance of doubt, the term “aperture” used herein does not imply a physical hole in the mask apparatus, but merely an area of the pattern which allows radiation to reach the detector; similarly “opaque” simply refers to part of the mask which does not allow incident radiation to reach the detector.

In published international patent application No. WO2006/125975, it has been proposed to use a reconfigurable coded aperture imaging system having a reconfigurable coded aperture mask apparatus. The use of a reconfigurable coded aperture mask apparatus allows different coded aperture masks to be displayed at different times. This allows, for example, the direction and field of view of the imaging system to be altered without requiring moving parts. Further the resolution of the imaging system can also be altered by changing the coded aperture mask displayed on the coded aperture mask apparatus.

WO2006/125975 teaches a versatile and lightweight imaging system that can be rapidly configured to have different fields of view or resolution without moving parts, other than perhaps some small moving parts in the coded aperture mask apparatus. It eliminates the need for conventional optics, gives conformal imaging capability, can have an infinite depth of field and gives inherent power free encryption since reconstruction of an image requires knowledge of the coded aperture array used. The imaging apparatus described in WO2006/125975 is particularly suitable for several imaging and surveillance applications in the visible, infrared or ultraviolet wavebands.

However, high resolution imaging requires small aperture sizes and a longer optical path from the detector to the mask, which increases diffraction effects. Diffraction causes a blurring of the pattern formed by the mask on the detector array, reducing its modulation and consequently having a detrimental effect on reconstructed image quality.

WO2007/091049 describes a processing method that takes several frames of data of the same scene, each frame of data acquired from a different coded aperture array, and processing the several frames together to improve image quality. The processing described therein recovers high quality images even in the presence of significant diffraction.

As mentioned above the resolution of a coded aperture imaging system having a certain detector pixel size is determined partly by the mask's aperture size and also by the mask to detector optical path length. Resolution could be improved by using a detector with smaller pixels but there is a limit on the pixel sizes that can be achieved and detectors with very small pixels can be more costly. However a greater path distance between the detector and the mask requires more or larger detector arrays to cover a given field of regard. The cost of the detector can be significant in a coded aperture imaging system and system size is of concern in some applications.

It is therefore an object of the present invention to provide an alternative method of processing for coded aperture imaging.

The present invention provides a method of forming an image of a scene, the method comprising using a coded aperture imaging system to acquire a plurality of frames of data using different coded aperture arrays, for each frame using a respective decoding pattern corresponding to the coded aperture array used to acquire that frame and processing the frames to provide an image solution which has a resolution greater than the detector's native resolution.

The present invention therefore uses data from a plurality of frames of data and uses the plurality of frames of data to provide a resolution greater than the native resolution of the detector, i.e. the method allows sub-pixel resolution to be achieved. The method involves constructing a solution to the data which is related to the true scene by an integral operator, the kernel of which is an averaging kernel. The averaging kernel can be though of as a point spread function for the whole process from the scene, to discrete data, to reconstructed scene. The averaging kernel typically has a main lobe and side lobes and the main lobe of the kernel is effectively a measure of resolution of the system. The method of the present invention ensure that the width of main lobe of the averaging kernel is smaller than the detector pixel size.

The method involves taking a plurality of frames of data each acquired using a different coded aperture mask. The decoding pattern for each mask is also needed. The decoding pattern may, in the case of no diffraction, be the aperture pattern of the mask. However in the case where diffraction is significant the decoding pattern will correspond to the point source diffraction pattern of the system, i.e. the intensity pattern a point source in the scene would produce on the detector. The decoding pattern for each mask may be calculated or may be determined through measurement. The decoding pattern, i.e. the point source diffraction pattern, should be known to high accuracy, i.e. a set of decoding patterns are required, for each mask aperture pattern, each corresponding to the point source varying on a sub-pixel scale.

The method involves solving the plurality of frames of data and decoding patterns. Conveniently the decoding patterns are combined in a Gram matrix. The Gram matrix, as will be understood by those skilled in the art, for a set of functions φₙ is given by Gₘₙ=<φₘ,φₙ>_{X}. For coded aperture imaging the functions φₙ are the point spread functions corresponding to a sub-pixel-shifted point source as measured at the detector.

For two dimensional data and decoding patterns the method may involve an initial step of applying a two dimensional to one dimensional mapping. This allows one dimensional linear algebraic techniques to be used to solve the inverse problem. Once solved the 1D solution can be unpacked back to a two dimensions to give the reconstructed image.

The multiple decoding patterns are incorporated into the Gram matrix and the matrix is increased in size by a factor of M in each dimension where M is the number of different mask patterns used.

The method then involves calculating a plurality of coefficient vectors fitting the data to the Gram matrix, i.e. the method involves solving

$${\sum }_{m = 1}^{N} {G}_{mn} {a}_{m} = {g}_{n}$$

where g is the data for coefficient vector a taking into account the known noise level.

Conveniently the coefficient vectors are determined by inverting the Gram matrix. In general the Gram matrix will be ill conditioned and the inversion will require regularisation. The inversion of the Gram matrix may be carried out using the Tikhonov regularisation however this does tend to increase the width of the averaging kernel and hence reduce resolution. As an alternative the inverse to the Gram matrix may be approximated by its pseudo-inverse and the pseudo-inverse truncated at an appropriate noise level. The method may therefore comprise the step of calculating the pseudo-inverse of the Gram matrix, G and truncating this pseudo-inverse.

The method may then involve reconstructing the normal solution using the coefficient vectors. The normal solution is given by

$$\hat{f} = {\sum }_{n = 1}^{N} {a}_{n} {φ}_{n} .$$

This results in a reconstructed image with sub-pixel resolution.

Using the above mentioned processing method for the entire scene could result in very large matrices for detectors with a large number of pixels—and, as mentioned above, the number of elements in the Gram matrix expands by a factor of M² where M is the number of mask patterns used.

The method may therefore involve the step of applying local processing to determine part of a scene image only. This relies on the fact that the diffraction pattern for a point source is relatively small. The method may therefore uses a sliding window approach comprising the step of taking a subset of the data from each frame corresponding to a part of the detector array, referred to as a detector box, and a corresponding subset of each decoding pattern and performing the method using only the subset of data and decoding pattern. The area of the detector box is related to the size of the diffraction pattern and should be at least the size of the diffraction pattern. Preferably however the detector box is about twice as large as the diffraction pattern in each dimension. To avoid artefacts, when the solution is produced only the solution at the centre of the window is maintained and an area of one diffraction pattern width is discarded. This significantly reduces the computational load in producing an image region. Multiple image regions can be processed in this manner and stitched together to give an overall image.

As the size of the diffraction pattern is important in determining the amount of computation required it is preferable that the data is acquired using a coded aperture image with a relatively compact point source diffraction pattern. The data may therefore be acquired using a coded aperture imaging system having at least one optical element located in the optical path to produce a compact diffraction pattern. The coded aperture imaging system used to acquire the data may therefore have one or more lenses, or elements having a focussing effect, to concentrate radiation onto the detector. It should be noted however that a coded aperture imaging system having a lens is quite different to a conventional imaging system which has a focusing lens. In a conventional imaging system the lens is used to focus radiation emitted from the scene to a point on the detector and the intensity pattern on the detector is the required image. When a lens is used in a coded aperture imaging system, the lens ensures a small diffraction spot size: however, the lens does not focus an image of the scene on the detector and processing is still required to reconstruct an image.

In another aspect, the present invention provides a coded aperture imaging system comprising a detector arranged to receive radiation from a scene via reconfigurable coded aperture mask apparatus having a processor for processing multiple frames of data acquired using different coded aperture masks to produce an image with a resolution greater than the native resolution of the detector. The processor is adapted to use the method of the present invention with all of the advantages thereof. The coded aperture imaging system may comprise one or more optical elements arranged radiation such that radiation reaching the detector is more concentrated than would be the case in the absence of the at least one optical element, i.e. the coded aperture imaging system comprises concentrating optics such as a lens or lenses.

In a further aspect, the present invention provides a coded aperture imaging system incorporating reconfigurable coded aperture mask apparatus arranged to provide a plurality of different coded aperture arrays which are changeable between frames of data, a detector comprising a pixel array for receiving radiation from a scene via the mask apparatus and for generating frames of data, the imaging system having a mask diffraction spot size which is smaller than the detector pixel size, and the imaging system including a processor for processing each frame of data with the aid of a respective decoding pattern corresponding to the coded aperture array used to acquire that frame and providing an image solution which has a resolution greater than the detector's native resolution.

The invention will now be described, by way of example only, with respect to the accompanying drawings, in which:

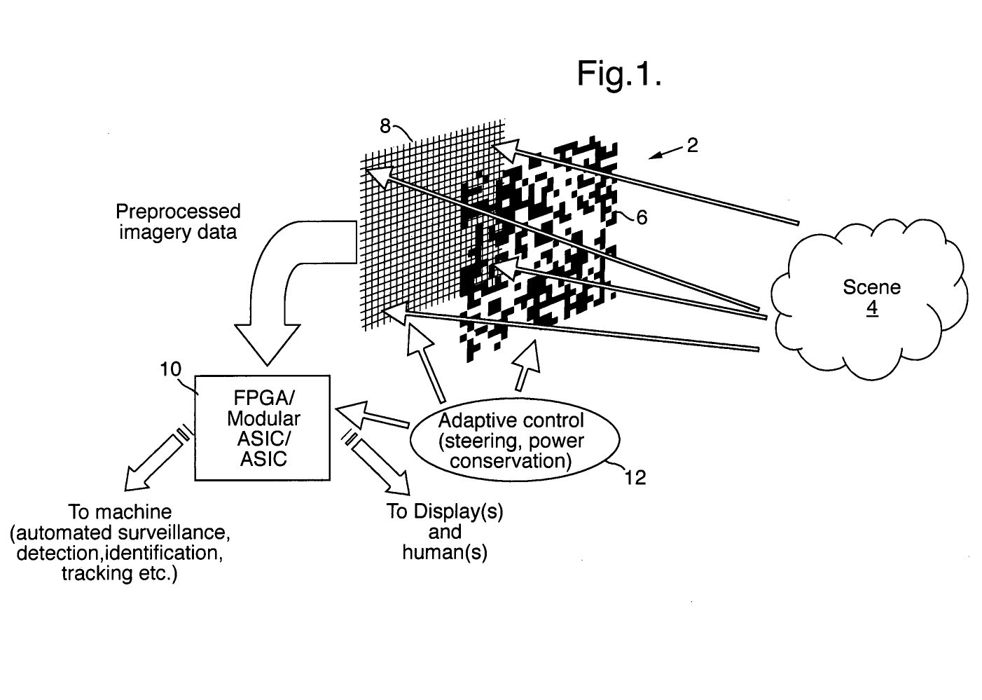

FIG. 1 shows schematically a coded imaging system such as described in WO2006/125975;

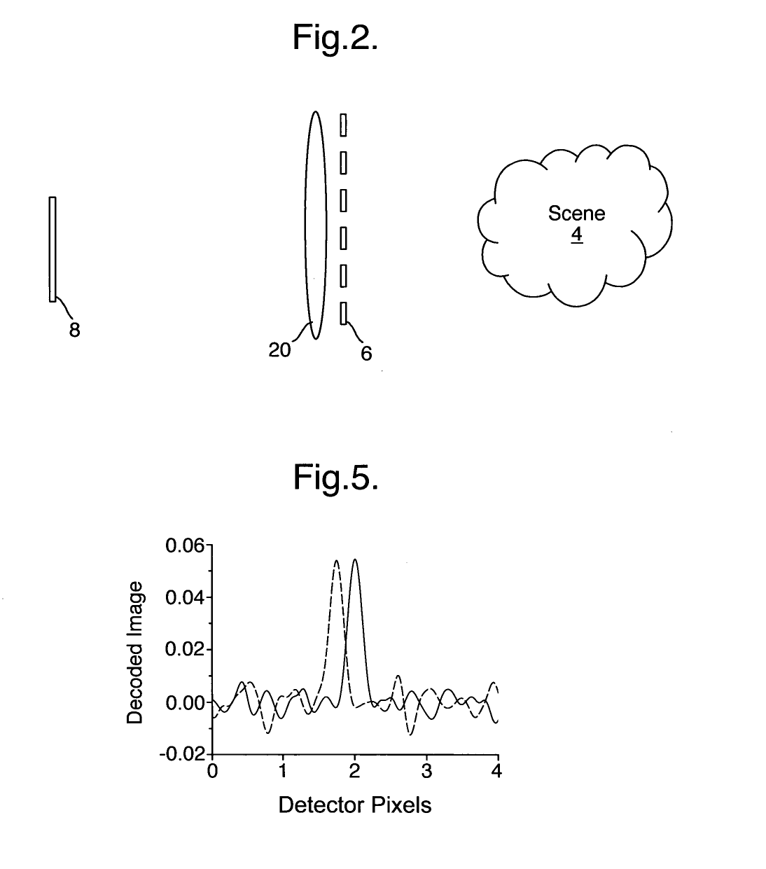

FIG. 2 shows an embodiment of a coded aperture imaging system including a lens;

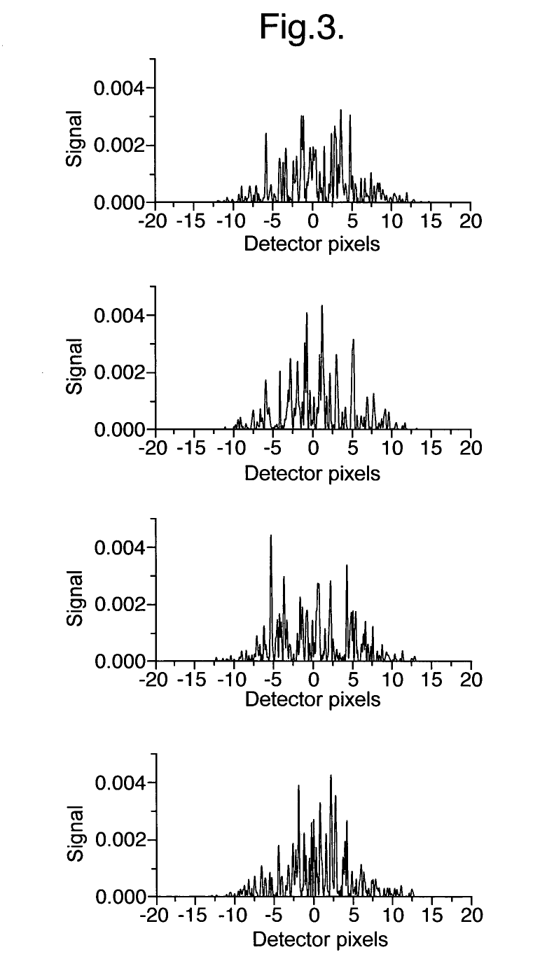

FIG. 3 shows the signal at the detector for four simulated point source mask diffraction patterns;

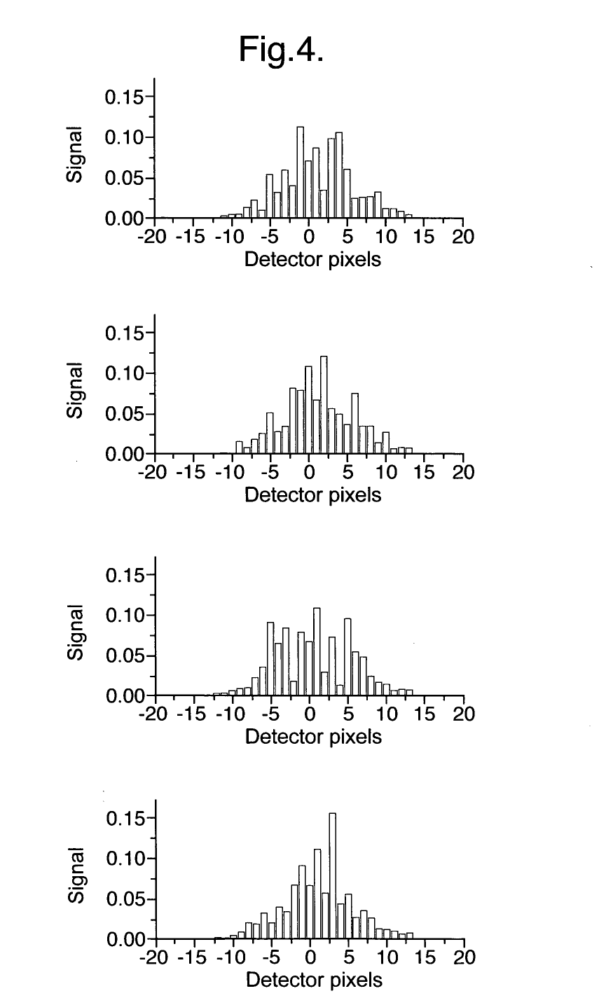

FIG. 4 shows pixellated versions of the patterns shown in FIG. 3;

FIG. 5 shows the reconstructed image intensity against detector pixels for two point sources using the method of the present invention;

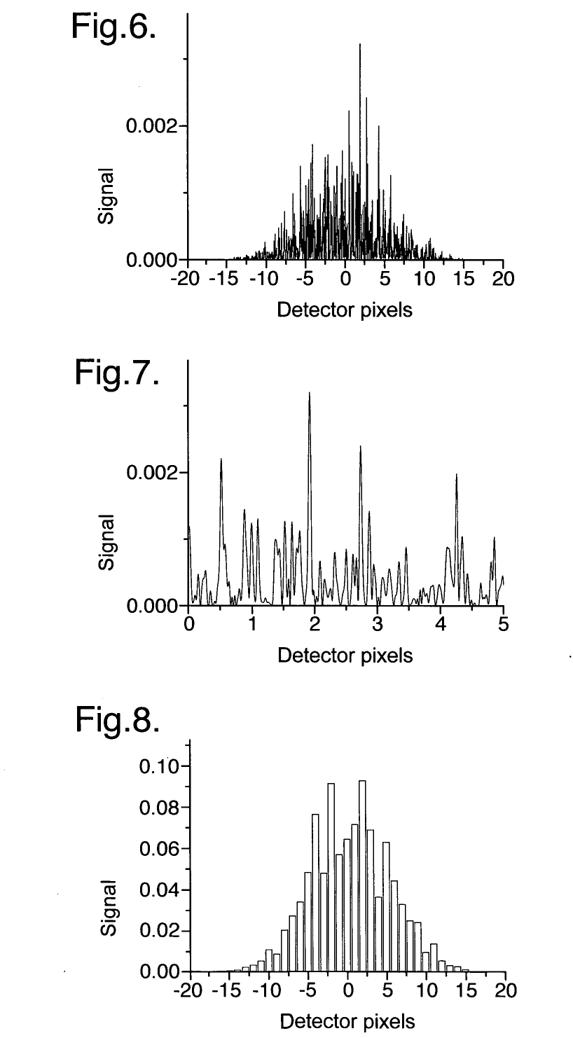

FIG. 6 shows a typical point source diffraction pattern;

FIG. 7 shows an expanded view of the pattern shown in FIG. 6;

FIG. 8 shows a pixellated form of the pattern of FIG. 6;

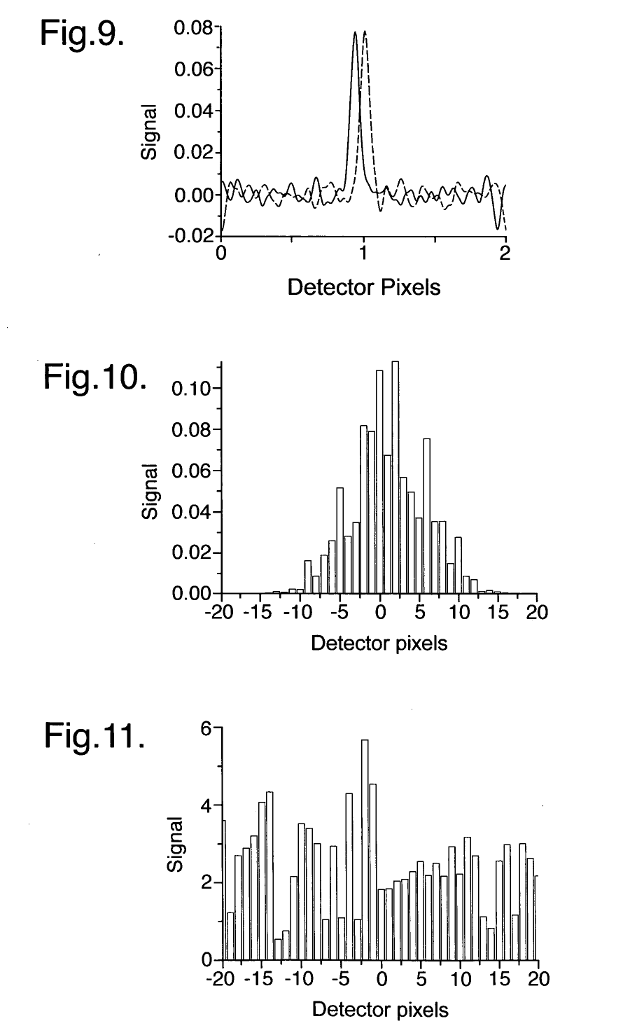

FIG. 9 shows the reconstructed image signal using the method of the present invention;

FIG. 10 shows a pixellated simulated detector signal;

FIG. 11 shows a simulated typical noise signal;

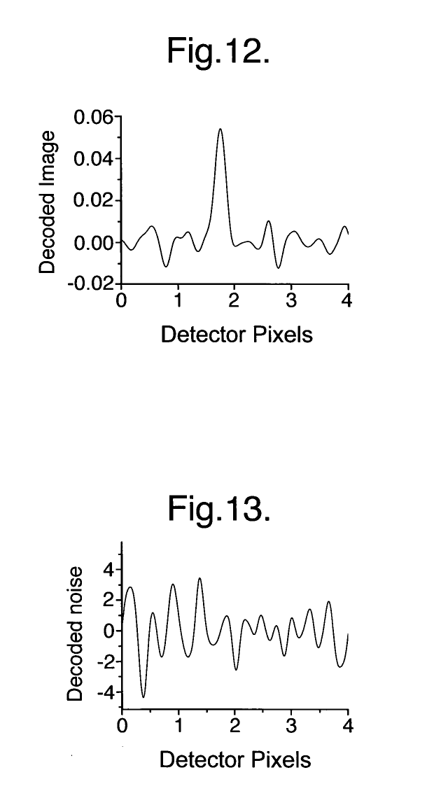

FIG. 12 shows the reconstructed signal component of the solution of the signals of FIGS. 10 and 11;

FIG. 13 shows a noise component of the solution of the signals of FIGS. 10 and 11;

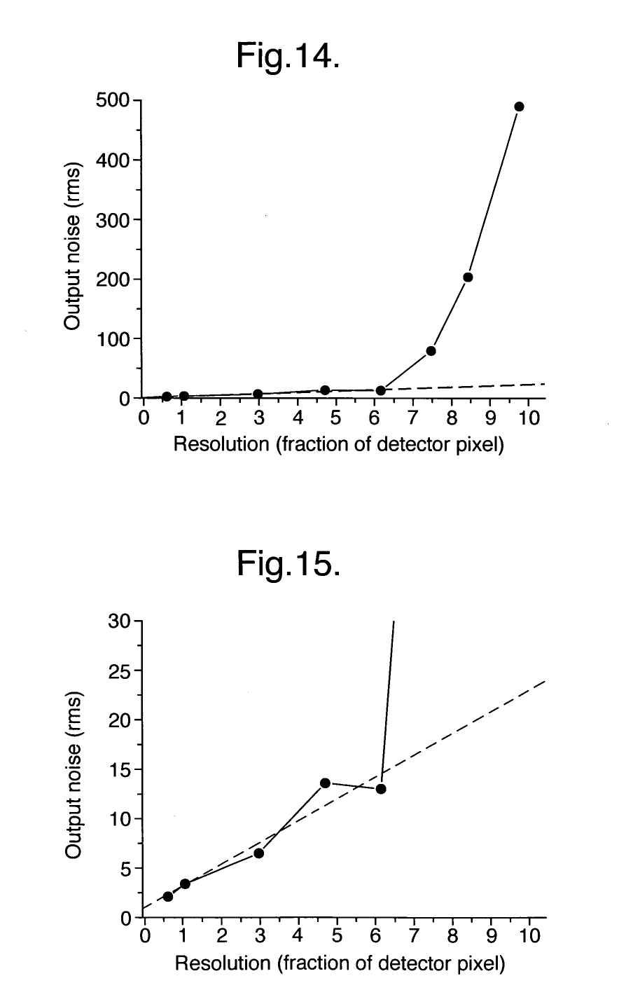

FIG. 14 illustrates the relationship between output noise level and resolution of the method of the present invention; and

FIG. 15 shows a magnified portion of the graph of FIG. 14 showing the relationship between noise level and resolution for lower values of resolution.

FIG. 1 shows schematically an example of a coded aperture imaging (CAI) system, indicated generally by 2. Rays of light indicated by arrows from points in a scene 4 fall on to a coded aperture array 6. The coded aperture array acts as a shadow mask and gives rise to a series of overlapping coded images on a detector 8 consisting of an array of pixels indicated by small squares. Each pixel receives respective intensity contributions from all of the overlapping coded images, and it sums those contributions. The detector 8 produces an output which is passed to a processor 10. The processor 10 decodes or reconstructs an image of the scene 4 from the detector output using any one of a variety of digital signal processing techniques.

Recently WO2006/125975 has proposed using a reconfigurable mask apparatus 6 to provide a reconfigurable coded aperture array which can be used where diffraction effects are significant. The coded aperture mask apparatus 6 is controlled by a controller 12 which controls the reconfigurable mask apparatus to display different coded aperture masks. If only part of the coded aperture mask apparatus displays a coded aperture array, the rest of the mask preventing radiation from reaching the detector, then the field of view of the apparatus is determined by the location and size of the coded aperture array relative to the detector, changing its position or size changes the field of view and/or resolution of the imaging system.

The ability to reconfigure the coded aperture mask rapidly not only allows the instantaneous field of view of the imaging system to be changed, but it also allows multiple frames of the same scene to be acquired. If each frame is captured using a different coded aperture mask, in processing the detector output the multiple frames can be used to improve image quality as taught in WO2007/091049.

CAI therefore offers the ability to provide a compact and lightweight imaging apparatus which has a large depth of field and has a changeable field of view without requiring bulky moving parts.

The present invention provides methods of processing the data recorded by a CAI system to produce sub-pixel resolution. This route to sub-pixel resolution relies on changing the mask pattern between frames: consequently, the invention employs a reconfigurable mask which may be implemented by modulating amplitude and/or phase of radiation incident upon it.

The method of the present invention is viable even where diffraction effects are significant. It uses a mask diffraction spot size which is smaller than the detector pixel size. The aim is then to retrieve the image at a resolution given by this spot size.

In order to ensure that the diffraction spot size is relatively small, the CAI system may advantageously contain one or more lenses. Such lenses act to concentrate the diffraction pattern on to a relatively small area of the detector. FIG. 2 illustrates an embodiment of a coded aperture imaging system which has a singlet lens 20 located in the optical path between the reconfigurable coded aperture mask 6 and the detector array 8, elements previously described being like referenced. The lens 20 is located in close proximity to the mask 6: it is arranged not to focus radiation from the scene 4 to a point but instead it acts as an angle multiplier or concentrator device and concentrates the photons passing through the mask 6 to a smaller area of the detector than otherwise would be the case. This has several advantages. It reduces the spread of the diffraction pattern ensuring that sub-pixel resolution can be achieved. Further, as will be described later, a compact point spread diffraction pattern can offer significant computational saving. Use of a lens is also beneficial in that the photon count per detector pixel from each point in the scene is increased compared to a CAI system 2 without a lens. The increased photon count per pixel can significantly improve signal to noise ratio. Furthermore, optical path equalisation is afforded by use of a lens, which can increase the CAI system's chromatic bandwidth.

Although FIG. 2 shows only a single lens, in practice a multi-element optical system may be used to provide the necessary optical characteristics and control over optical aberrations.

It is possible to analyse coded-aperture imaging as if the detector samples the data at points and finite detector pixel widths are ignored. However, this approach puts a bound on resolution performance and to go beyond this bound one needs to incorporate the effects of finite detector pixel width. The concept of an averaging kernel is now introduced, which can be thought of as a point-spread function for a whole process from scene to discrete data to reconstructed image of a scene. The averaging kernel typically has a main lobe and sidelobes, and the width of the main lobe can be regarded as a measure of resolution for the system. As with linear inverse problems with continuous data, the reconstruction process can be unstable and regularisation is needed to guarantee a smooth dependence of the reconstructed image of a scene on the data.

The mathematical analysis presented below is for one-dimensional problems to simplify description: it is extendable to two dimensions.

There is a basic equation governing linear inverse problems with discrete data is (see Linear inverse problems with discrete data. I: General formulation and singular system analysis. M. Bertero, C. de Mol, E. R. Pike, Inverse Problems 1 (1985) pp 301-330.). This equation is:

gₙ=∫P(yₙ−y)(∫K(y,x)ƒ(x)dx)dy, n=1, . . . ,N (1)

where gₙ represents the data, P represents blurring due to a sampling process (e.g. integration over a detector pixel area), K(y,x) represents instrumental response (i.e. the mask diffraction pattern) and ƒ(x) is a scene of which an image is to be reconstructed, (assumed) to lie in an infinite-dimensional space X). X can be assumed to be the space of square-integrable functions L² without loss of generality, because any scene must have a finite total intensity squared associated with it. In considering sub-pixel resolution, it would be incorrect to insist that f lie in some discrete space with pixels the same size as the data pixels. The space X has a scalar product defined on it as follows:

<g,h>_{X}=∫g(x)h(x)dx

The right hand side of Equation (1) is a linear functional on a space of possible scenes, so Equation (1) may be rewritten as:

gₙ=Fₙ(ƒ), n=1, . . . ,N

where Fₙ are functionals assumed to be continuous maps from X to the real numbers: consequently, the Riesz representation theorem may be used to write:

Fₙ(ƒ)= [symbol] ƒ,φₙ [symbol] _{X}, n=1, . . . ,N

for some set of functions φₙ. Inspection of (1) indicates that the φₙ are simply given by

φₙ(x)=∫P(yₙ−y)K(y,x)dy

The inverse problem then becomes to determine a function f which satisfies:

gₙ= [symbol] ƒ,φₙ [symbol] _{X}, n=1, . . . ,N (2)

It is assumed that the functions φₙ are linearly independent (though not necessarily orthogonal). Let X_{N} be the finite-dimensional subspace of X spanned by the φₙ, n=1 to N. to the linear independence of the functions φₙ this subspace will be N-dimensional. There is another subspace of X which consists of all the functions which are orthogonal to the set of φₙ: denote this subspace by X_{N}^{⊥}, so that X=X_{N}⊕X_{N}^{™}. This indicates that the solution to the inverse problem is not unique. To a solution to this problem any function lying in X_{N}^{⊥} can be added to get another solution which agrees with the data. The solution (amongst all possible solutions) which has minimum 2-norm is referred to as the normal solution. This solution lies in X_{N}.

The normal solution to the problem \hat{ƒ} (since it lies in X_{N}) is given by

$$\hat{f} = {\sum }_{n = 1}^{N} {a}_{n} {φ}_{n}$$

Since \hat{ƒ} satisfies Equation (2), the aₙ satisfy

$${\sum }_{m = 1}^{N} {G}_{mn} {a}_{m} = {g}_{n}$$

where G is the Gram matrix associated with the functions φₙ, given by

Gₘₙ=<φₘ,φₙ>_{X}

Let G⁻¹ be the inverse of the Gram matrix and define in X_{N} the dual basis φⁿ given by

$${φ}^{n} = {\sum }_{m = 1}^{N} {G}_{nm}^{- 1} {φ}_{m}$$

Then the normal solution is given by

$$\hat{f} = {\sum }_{n = 1}^{N} {g}_{n} {φ}^{n}$$

An averaging kernel A(x,x′) is now defined as follows:

$$A ( x , {x}^{′} ) = {\sum }_{n = 1}^{N} {φ}^{n} ( x ) {φ}_{n}^{*} ( {x}^{′} )$$

A(x,x′) typically has the form of a main-lobe and sidelobes.

It can be shown that the normal solution is related to the true scene via

\hat{ƒ}=Af

where A is the integral operator whose kernel is the averaging kernel. The width of the main lobe of the averaging kernel is a measure of resolution for the CAI system.

The averaging kernel can be rewritten as

$$A ( x , {x}^{′} ) = {\sum }_{n , m = 1}^{N} {( {G}^{- 1} )}_{mn} {φ}_{m} ( x ) {φ}_{n} ( {x}^{′} ) \qquad ( 3 )$$

In general the Gram matrix G will be ill-conditioned and its inversion requires regularisation. This will affect the achievable resolution. By regularisation of the inverse of the Gram matrix is meant some approximation ρ_{μ}^{nm} such that

$${lim}_{μ -> 0} {ρ}_{μ}^{nm} = {( {G}^{- 1} )}_{nm}$$

where μ is a regularisation parameter. The degree of regularisation will depend on the signal-to-noise ratio.

The inversion of the Gram matrix can be carried out using Tikhonov regularisation. As with conventional Tikhonov regularisation, increasing the regularisation parameter leads to a decrease in resolution, i.e. an increase in width of the main lobe of the averaging kernel. An alternative way of regularising is to approximate the inverse of the Gram matrix by its pseudo-inverse and to truncate the pseudo-inverse at a suitable tolerance reflecting the noise level. The pseudo-inverse is written in terms of the singular value decomposition of the Gram matrix and only those terms corresponding to singular values above a given threshold are retained. This threshold depends on the noise level. There is a close relationship between Tikhonov regularisation and regularisation by truncating the singular-value expansion of the pseudo-inverse.

Denote the singular-value decomposition of the Gram matrix by

G=VΣU^{T}

where U and V are orthogonal matrices and Σ is a diagonal matrix with the singular values arranged in decreasing order down the diagonal. Note that V=U due to the symmetry of G. The pseudo-inverse of G is given by

G^{PI}=UΣ^{I}V^{T}

where Σ^{I} is a diagonal matrix containing the reciprocals of the singular values on its diagonal, up to the point where the singular values are zero. Beyond this point the diagonal elements of Σ^{I} are set to zero. Regularisation involves setting further reciprocals of the singular values in Σ^{I} to zero, the number of these depending on the signal to noise ratio.

An integral operator Φ is now introduced whose kernel is:

Φ(i,x)=φᵢ(x)

This operator has a singular-function expansion

Φ=U\tilde{Σ}W^{T}

where W^{T} contains N singular functions spanning (in the absence of zero singular values) the space X_{N}. The diagonal matrix of singular values, \tilde{Σ}, is related to that of the Gram matrix by

\tilde{Σ}²=Σ

In order to determine the truncation point for the pseudo-inverse of the Gram matrix we look at \tilde{Σ} and set to zero all the singular values which are less than the inverse of the signal-to-noise ratio. Hence the truncation of the pseudo-inverse of the Gram matrix is determined by the reciprocal of the square of the signal-to-noise ratio. Inserting this truncated pseudo-inverse into the averaging kernel then gives the resolution for a particular signal-to-noise ratio.

The foregoing analysis will now be applied to coded-aperture imaging. From equations (1) and (2), the functions φₙ are given by

φₙ(x)=∫P(yₙ−y)K(y,x)dy

In optics, a point spread function is a useful quantity for characterising an imaging system: it is defined as a pattern of light produced on a detector array in an optical system by a point source of light located in a scene being observed by the system. For coded-aperture imaging the functions φₙ represent point-spread functions corresponding to a point source at x as measured on the detector array, i.e. the modulus-squared of the mask diffraction pattern with integration over detector pixels.

The Gram matrix is given by

Gₘₙ=∫(∫P(yₙ−y)K(y,x)dy)(∫P(yₘ−y′)K(y′,x)dy′)dx

By interchanging the order of integration this may be written in the form

Gₘₙ=∫∫P(yₙ−y)L(y,y′)P(yₘ−y′)dydy′

where

L(y,y′)=∫K(y,x)K(y′,x)dx

is the autocorrelation of the diffraction pattern for the case of continuous data. In order to evaluate this we require knowledge of the mask+lens diffraction pattern to sub-pixel accuracy.

From the foregoing analysis, the basic method of scene reconstruction is as follows:

1. Construct the Gram matrix G using the known point-source diffraction pattern.

### 2. Solve

$${\sum }_{m = 1}^{N} {G}_{mn} {a}_{m} = {g}_{n}$$

where g is the data, for coefficient vector a, taking into account the known noise level.

This is usually done by calculating the pseudo-inverse of the matrix G. In the presence of noise the pseudo-inverse needs to be truncated at a certain tolerance to prevent the solution “blowing up”.

3. Reconstruct the normal solution

$$\hat{f} = {\sum }_{n = 1}^{N} {a}_{n} {φ}_{n}$$

In practice, the functions φ are not continuous, but are discretized in the x dimension at a scale finer than the desired resolution.

Changing the mask pattern will now be discussed. The functions φₙ span the subspace X_{N} defined earlier. In order to achieve resolution enhancement as compared to a static single mask case, this subspace has to be enlarged to include some functions which were previously in X_{N}^{⊥}. One way to resolution enhancement is to record more data with a different mask pattern. Suppose one such pattern change is carried out: it will give rise to new data which will have a corresponding new set of functions ψₙ, say, and there is a possibility that an averaging kernel which corresponds to the set{φₙ,ψₙ} will have a main lobe narrower than that corresponding to just the previous functions φₙ.

For resolution enhancement, the functions ψₙ are to be linearly independent of the functions φₙ: if they are not then the Gram matrix corresponding to the set{φₙ,ψₙ} will have reduced rank and the averaging kernel will have the same main-lobe width as that for the set of φₙ alone.

The averaging kernel corresponding to the set of φₙ alone for the noiseless case (i.e. with the regularisation parameter set equal to zero) represents the best resolution achievable without enlarging the subspace X_{N}. To go beyond this resolution new functions ψₙ must be introduced which are linearly independent of the functions φₙ.

The resolution can be analysed in terms of a fundamental theorem on linear systems of equations which states that one needs as many equations as unknowns. In the context of coded aperture imaging this means that the number of detector pixels times the number of mask patterns needs to be equal to the number of resolution cells. So, in one dimension, to get 1/Mth of a pixel resolution at least M different masks are required. In two dimensions to resolve M sub-pixels at least M masks are required.

The basic algorithm for image reconstruction in coded aperture imaging can be modified to incorporate the use of multiple mask patterns. The pixel index in the functions φₙ and the Gram matrix is converted to a combined mask-pattern and pixel index. This may be done by interleaving the pixel and mask indices. For two masks odd indices correspond to a first mask, mask 1, and even indices to a second mask, mask 2.

Extension to more than two masks is as follows. For M masks the combined pixel/mask number index is reduced modulo M to retrieve the mask number. The pixel number is given by one plus the integer part of the combined pixel/mask number index divided by M.

The Gram matrix is increased in size by a factor of M in each dimension where M is the number of mask patterns used.

Simulations were conducted to demonstrate the principles described above.

Referring now to FIG. 3, a one dimensional simulation using four different point source mask diffraction patterns is shown. In pixellated form these patterns are as shown in FIG. 4.

FIG. 5 shows results obtained by applying the above multi-mask decoding algorithm to a scene consisting of two points spaced a quarter of a pixel apart. The two curves in FIG. 5 represent the two reconstructed point sources. Since the algorithm is linear the result of applying it to a sum of two point sources is the same as summing the results of applying the algorithm to each point source in turn.

For a 16^{th} of a pixel resolution at least sixteen different mask patterns are required. FIG. 6 shows a typical point source mask diffraction pattern. To show the fine structure of this pattern a small magnified portion is shown in FIG. 7. It will be seen that the finest structure is chosen to be of the same order as the sub-pixel resolution required. The pixelated form of the pattern in FIG. 6 is shown in FIG. 8.

Using sixteen masks with the FIG. 6 point source mask diffraction pattern yields the result shown in FIG. 9, which shows two curves representing two reconstructed point sources. The explanation for the two curves is the same as that for FIG. 5. FIG. 9 shows that 1/16^{th} pixel resolution is possible using sixteen different mask patterns if the feature size in the point source diffraction pattern is of the same size.

A noise analysis will now be carried out. Detector noise is additive and the multi-mask decoding algorithm is linear, so the solution can be written as a sum of signal and noise components. A detector output signal for processing using the algorithm is assumed to be of the form shown in FIG. 10, and a noise signal is assumed to be of the form shown in FIG. 11. The algorithm gives rise to a solution with a signal component shown in FIG. 12, and a noise component is shown in FIG. 13.

A smaller tolerance in the pseudo-inverse gives higher resolution but greater RMS noise.

The decoded noise level may be plotted against resolution in order to see the effect of changing the tolerance in the pseudo-inverse of the Gram matrix. FIG. 14 is a plot of root-mean-square (rms) noise level against resolution relative to the output noise produced when decoding the pixelated data by correlation with a reference pattern. FIG. 15 shows part of FIG. 14 on an expanded vertical scale. The relationship between the two forms of noise is approximately linear for lower resolution as can be seen from FIG. 15.

To obtain these results 16 diffraction patterns were used, with a feature scale in each pattern of the order of ⅙^{th} of a pixel. It is notable that the output noise increases very steeply when the resolution exceeds this scale.

Extension of the multi-mask decoding algorithm to two dimensions is as follows:
1. Map a two-dimensional scene coordinates x1, x2 to single coordinate x;
2. Map a two-dimensional detector pixel indices (i, j) to single index k;
3. Map single index k and mask pattern identifier l to single index (as in the multi-mask one-dimensional algorithm)
4. Use a one-dimensional algorithm
5. Undo the two-dimensional to one-dimensional mapping to obtain the solution in two dimensions.

An example of a mapping from two dimensions to one dimension is lexicographic mapping as follows:

k=i+N(j−1); i=rem(k/N), j=int(k/N)+1.

Using this processing method for an entire scene (global processing) would result in very large matrices—the Gram matrix would typically have ˜10⁶×10⁶ elements for the full-size problem (with a single mask pattern). This would result in a large processing overhead which may not be appropriate for some applications.

However, the diffraction pattern for a point source is relatively small, so information about a given point in the scene is contained within a small region and local processing can be used. In addition, some applications may require high resolution in small parts of the scene at a time, i.e. points of interest within the scene.

Local processing can cope with a diffraction pattern that varies across the scene. Hence, a sliding window approach can be used to scan through the required part of the scene, just using data within the “detector box”—a small portion of the entire detector array. One then solves within the “reconstruction box” and retains the solution only in the middle of the reconstruction box (“solution box”), discarding an area of one diffraction pattern width.

The complexity of this approach depends on the size of the detector box required for local reconstruction: if the size of the diffraction pattern is N×N pixels then Fish et al. (A scanning singular-value decomposition method for restoration of images with space-variant blur. D. A. Fish, J. Grochmalicki and E. R. Pike, J. Opt. Soc. Am. A, 13, no 3, March 1996, pp 464-469) suggest the size of the detector box should be about (2N−1)×(2N−1) pixels. For example, with N=20 we have a 392×392 Gram matrix. If M masks are used this increases to M²×392×392 elements.

The computational load is thus a strong function of the size of the point-source diffraction pattern, and from this point of view a compact diffraction pattern is desirable.

The present invention therefore allows sub-pixel resolution to be achieved in coded aperture imaging processing.

1. A method of forming an image of a scene, the method comprising using a coded aperture imaging system to acquire a plurality of frames of data using different coded aperture arrays, for each frame using a respective decoding pattern corresponding to the coded aperture array used to acquire that frame and processing the frames to provide an image solution which has a resolution greater than the detector's native resolution.

2. A method as claimed in claim 1 comprising the step of constructing a solution to the data which is related to the true scene by an integral operator having an averaging kernel with a width of main lobe which is smaller than the detector pixel size.

3. A method as claimed in claim 1 or 2 wherein each decoding pattern corresponds to a point source diffraction pattern of the coded aperture imaging system for the particular mask.

4. A method as claimed in any preceding claim comprising an initial step of applying a two-dimensional to one-dimensional mapping to each frame of data, processing the data to provide a one-dimensional image solution and subsequently unpacking the one-dimensional image solution to form a two-dimensional image.

5. A method as claimed in any preceding claim wherein the decoding patterns are combined in a Gram matrix.

6. A method as claimed in claim 5 further including the step of calculating a plurality of coefficient vectors which fit the plurality of frames of data to the Gram matrix, the coefficient vectors being determined by inverting the Gram matrix.

7. A method as claimed in claim 6 wherein the Gram matrix is inverted either by Tikhonov regularisation or by calculating a truncated pseudo-inverse of the Gram matrix.

8. A method as claimed in claim 6 or 7 including the step of reconstructing the image solution using the coefficient vectors.

9. A method as claimed in any preceding claim comprising determining part of a scene image by defining a data window consisting of a subset of the data from each frame corresponding to a part of the detector array, obtaining a corresponding subset of each decoding pattern and performing the method using the data subset and the decoding pattern subset.

10. A method as claimed in claim 9 wherein the size of the subset of the data from each frame is substantially twice as large in each dimension as the size of the point source diffraction pattern at that part of the detector.

11. A method as claimed in claim 9 or 10 including maintaining an image solution at the data window's centre and discarding an area with a width of one point source diffraction pattern.

12. A method as claimed in claim 1 where the data is acquired using a coded aperture imaging system having at least one optical element located in the optical path to produce a compact diffraction pattern.

13. A coded aperture imaging system comprising a detector for receiving radiation from a scene via reconfigurable coded aperture mask apparatus, having a processor for processing multiple frames of data acquired using different coded aperture masks to produce an image with a resolution greater than the native resolution of the detector.

14. A coded aperture imaging system as claimed in claim 13 comprising at least one optical element arranged such that radiation reaching the detector is more concentrated than would be the case in the absence of the at least one optical element.

15. A coded aperture imaging system incorporating reconfigurable coded aperture mask apparatus arranged to provide a plurality of different coded aperture arrays which are changeable between frames of data, a detector comprising a pixel array for receiving radiation from a scene via the mask apparatus and for generating frames of data, the imaging system having a mask diffraction spot size which is smaller than the detector pixel size, and the imaging system including a processor for processing each frame of data with the aid of a respective decoding pattern corresponding to the coded aperture array used to acquire that frame and providing an image solution which has a resolution greater than the detector's native resolution.
